(19) United States
(12) Patent Application Publication
(10) Pub. No.: US 2009/0158038 A1
(43) Pub. Date: Jun. 18, 2009

(54) UNIVERSAL AUTHENTICATION METHOD

(76) Inventor: James Ng, Seattle, WA (US)

Correspondence Address: CLOUTIER & ENGLE, PLLC;ATTN: PRIYA SINHA CLOUTIER, 320 DAYTON STREET, SUITE 260, EDMONDS, WA, 98020, US

(21) Appl. No.: 11/956,559

(22) Filed: Dec. 14, 2007

(51) Int. Cl. H04L 9/00

(52) U.S. Cl. 713/168

(57) ABSTRACT

The present invention is directed to a universal authentication method that is more secure than conventional methods found on most electronic systems. The universal authentication method does not send passwords over hard wires or wireless systems. Consequently, it is difficult for would be password thief to intersect password data. It can also provide a further layer of security by providing rotating passwords.

The universal authentication method also provides security against a “middle man” type scam. Scammers will e-mail an unsuspecting internet user about problems with his bank account, for example, and request the user to rectify the problems providing a link to follow. The link takes the user to a websites that looks exactly like the banks website. When the user enters his username and password to this bogus website, the information is passed on to the real bank website allowing the scammer access to the user's bank account. The universal authentication method provides web site authentication security by using the website name as an identifier and adding the IP address of the website as part of the encryption key. And, because users do not need to remember or generate passwords, the encryption key can be totally random in size and nature.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

On a daily basis, most modern men interface with multiple electronic systems such as personal computers, personal digital media devices, cell phones, PDA, among others. Each electronic system has a different passwords requiring modern man to remember a multitude of information that can be easily lost or stolen. The amount of information modern man is required to remember increases substantially when one accounts for the passwords and/or usernames needed to use applications, including but not limited to web sites, which are run on the electronic systems.

Passwords are limited in length and content by what a user can remember. Additionally, conventional authentication systems are easily infiltrated because both the authentication code and password are stored within the system. Consequently, if a laptop, for example, is stolen, the data stored within is easily accessible.

Information relevant to attempts to address these problems can be found in Blom, U.S. Pat. No. 7,194,766; Yokoto et Al., U.S. Pat. No. 7,155,607; Venters et al., US Publication No. 2007/0256140; Prafullchandra et. al., Us Publication No. 2007/0256143. However, each of these references suffers from one or more of the following disadvantages:

(a) does not provide a check for bogus websites which will replicate the identifier;
(b) passes passwords over a wire where it can be intercepted by unauthorized users; and
(c) passwords are limited in size and type.

The object of the current authentication method is to provide the user with an authentication method that is more secure than conventional authentication methods and can be used on personal computers, PDAs, cell phones, personal digital media devices, home and car lock and security systems, television/VCR/DVD remote controls, credit card authentication systems, automatic teller machine authentication systems, among others.

### BRIEF SUMMARY OF THE INVENTION

The present invention is directed to an universal authentication method that is more secure than conventional methods found on most electronic systems. The universal authentication method does not send passwords over hard wires or wireless systems. Consequently, it is difficult for would be password thief to intersect password data. It can provide a further layer of security by providing rotating security information.

The universal authentication method also provides security against a “man in the middle” type scam. Scammers will e-mail an unsuspecting internet user about problems with his bank account, for example, and request the user to rectify the problems providing a link to follow. The link takes the user to a websites that looks exactly like the bank's website. When the user enters his username and password to this bogus website, the information is passed on to the real bank website allowing the scammer access to the user's bank account. The universal authentication method provides web site authentication security by using the website name as an identifier and adding the IP address of the website as part of the encryption key. And, because users do not need to remember or generate passwords, the encryption key can be totally random in size and nature.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which.

FIG. 1: Flow chart of a conventional authentication method;

FIG. 2: Flow chart of the universal authentication method.

### DETAILED DESCRIPTION OF THE INVENTION

The universal authentication method is a challenge-response method which does not require the user to generate or remember passwords. It may reside on the electronic system as an auxiliary application or reside on the hardware specific for the authentication method. The term electronic system(s) is used to describe systems such as personal computers, personal digital media devices, cell phones, PDAs, among others. This list is not exclusive. The universal authentication method can be used for one and two way authentication. In the universal authentication method the challenger or requester can be either the user or the electronic system.

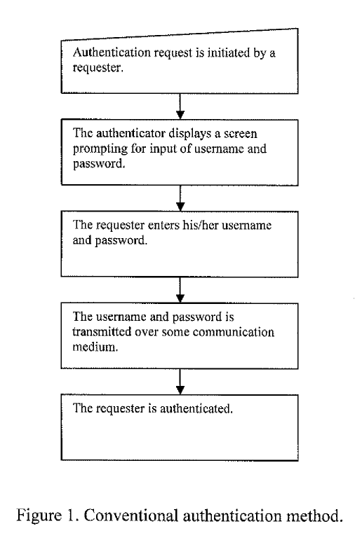

As seen from FIG. 1, in conventional authentication methods the authenticator is the electronic system. The authenticator displays a screen prompting for username and password or password. The user or requester enters his username and password or password. Because the human requester, can remember only a limited number and type of symbols consequently, usernames and passwords are limited in size and content. Conventional authentication methods also allow would be thief easy access to passwords and usernames.

Electronic systems that use the conventional authentication method usually store usernames and passwords within the electronic system. If, for example, an electronic system is stolen, a thief can, by using the numerous brute force programs available, determine the usernames and passwords to that particular electronic system as well as usernames and passwords that may be stored in the electronic system for other electronic system.

Some electronic systems accept authentication data via internet protocol technology. This requires the user to pass along his username and password through cyberspace; a place where this information can be intercepted.

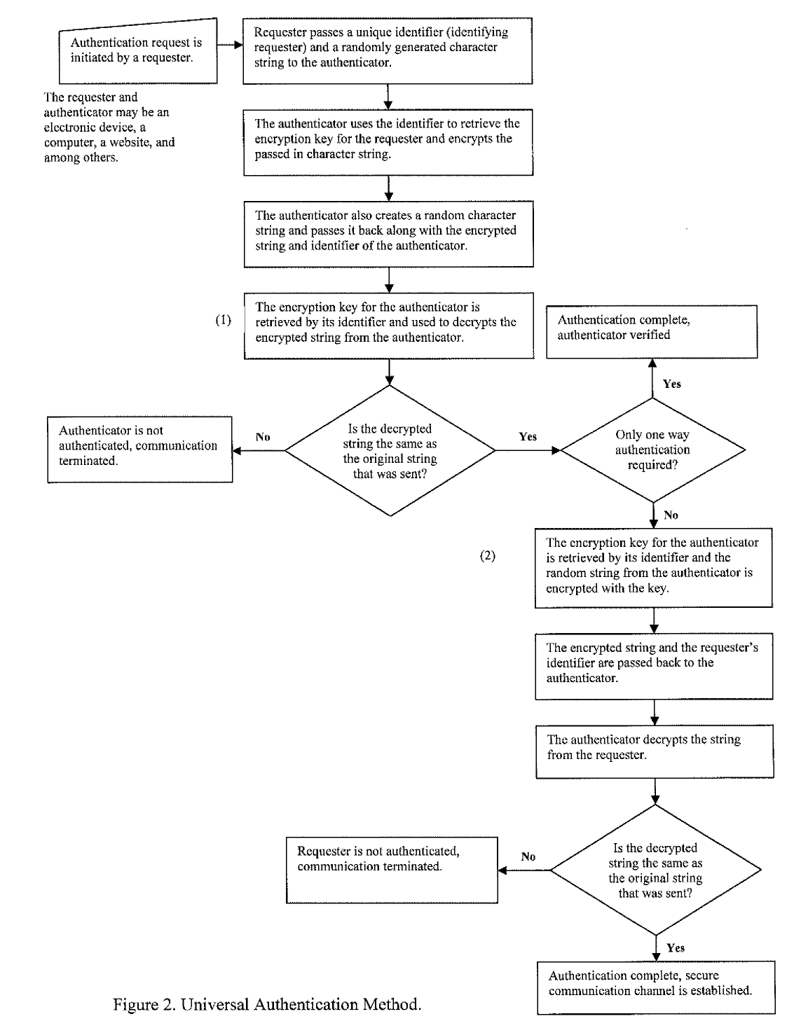

The universal authentication method removes these barriers, among others, by removing the human user from the equation. As shown in FIG. 2, the universal authentication method comprises of methods for one and two way authentication.

In one way authentication the requester makes a request for authentication to the authenticator. The authenticator passes a unique identifier and randomly generated character string to the requester. The requester uses the identifier to retrieve an encryption key for the authenticator and encrypts the passed in randomly generated character string. The encrypted randomly generated character string, and an identifier which uniquely identifies the requester, is passed back to the authenticator. The authenticator retrieves an encryption key, which corresponds to the identifier, and decrypts the encrypted string. If the decrypted character string matches the random character string sent in the initial request, the requester is authenticated.

In two way authentication the authenticator passes its unique identifier and randomly generated character string to the requester. The requester uses the identifier to retrieve an encryption key for the authenticator and encrypts the randomly generated passed in character string. The encrypted character string, an identifier which uniquely identifying the requester, and a new randomly generated character string is passed back to the authenticator. The authenticator retrieves the encryption key corresponding to the received identifier, and decrypts the encrypted character string. If the decrypted character string does not match the random character string sent in the initial request, authentication fails and communication is terminated.

If the decrypted character string matches the random character string sent in the initial request, the random character string from the requester is encrypted. The encrypted character string is passed back to the requester along with the authenticator's identifier. The requester uses the identifier to retrieve the encryption key for the authenticator and decrypts the encrypted string. If the decrypted character string matches the random character string sent in the initial request, both parties are authenticated. In two way authentication method the universal authentication system can use either one or two encryption keys.

When two encryption keys are used, one key is designated for incoming requests and another is designated for outgoing responses. Users of the universal authentication method can also request rotating encryption key(s); either a single encryption key or one encryption key for incoming requests and one encryption key for outgoing responses. For website authentication, the IP address of the requester and authenticator can be added as part of the encryption key(s) to prevent “man in the middle” scams.

In view of the above, it will be seen that various aspects and features of the invention are achieved and other results and advantages can be attained. While preferred embodiments of the invention have been shown and described, it will be obvious to those skilled in the art that changes and modification may be made therein without departing from the invention in its broader aspects.

What is claimed:

1. a method for one way authentication using a challenge and response system where a first apparatus (requester) initiates a request for authentication to a second apparatus (authenticator), the method comprising the steps of:
a. the authenticator passing its unique identifier and a randomly generated character string to the requester;
b. the requester uses the identifier to retrieve an encryption key for the authenticator and encrypts the passed in randomly generated character string;
c. the encrypted character string and the requester's unique identifier is passed back to the authenticator;
d. the authenticator retrieves the encryption key that corresponds to the received identifier and decrypts the encrypted character string;
e. if the decrypted character string matches the random character string sent in the initial request, the requester is authenticated

2. the encryption key of claim 1 is determined from a plurality of rotating encryption keys;

3. the rotation of encryption keys of claim 2 is determined by a predefined pattern in the randomly generated character string of claim 1;

4. a means to determine the rotation of encryption keys of claim 2;

5. the authentication method of claim 1 is configured to authenticate a website by using the website name as an identifier;

6. the authentication method of claim 1 uses the IP address of the website as part of the encryption key;

7. a method for two way authentication using a challenge and response system where a first apparatus (requester) initiates a request for authentication to a second apparatus (authenticator), the method comprising the steps of:
a. the authenticator passing its unique identifier and a randomly generated character string to the requester;
b. the requester uses the identifier to retrieve an encryption key for the authenticator and encrypts the passed in randomly generated character string;
c. the encrypted character string, the requester's unique identifier, and a new randomly generated character string is passed back to the authenticator;
d. the authenticator retrieves the encryption key corresponding to the received identifier and decrypts the passed back encrypted character string;
e. if the decrypted character string does not match the random character string sent in the initial request, authentication fails and communication is terminated;
f. if the decrypted character string matches the random character string sent in the initial request, the random character string from the requester is encrypted;
g. the encrypted character string is passed back to the requester with the authenticator's unique identifier;
h. the requester uses the identifier to retrieve the encryption key for the authenticator and decrypts the encrypted character string;
i. if the decrypted character string matches the random character string sent in the initial request, both parties are authenticated

8. the method of claim 7 uses one encryption key;

9. the method of claim 7 uses one encryption key for incoming requests and one encryption key for outgoing requests;

10. the encryption key of claim 7 is determined from a plurality of rotating encryption keys;

11. the rotation of the encryption keys of claim 10 is determined by a predefined pattern in the randomly generated character string of claim 7;

12. a means to determine the rotation of encryption keys of claim 10;

13. the authentication method of claim 7 is configured to authenticate a website by using the website name as an identifier;

14. the authentication method of claim 7 uses the IP address of the website as part of the encryption key.
